(19) United States
(12) Patent Application Publication
(10) Pub. No.: US 2021/0095076 A1
(43) Pub. Date: Apr. 1, 2021

(54) HIGH MODULUS COLORLESS POLYIMIDE FILM AND METHOD OF PREPARATION

(71) Applicant: Goldengate Quantum Technology Co. Ltd., Shanghai (CN)

(72) Inventors: YanYan JIANG, Shangrao City (CN); Xi REN, Yueyang City (CN); ZhenZhong WANG, Zhuzhou City (CN); LiGuo XIAO, Wugang City (CN)

(21) Appl. No.: 16/601,950

(22) Filed: Oct. 15, 2019

(30) Foreign Application Priority Data
Sep. 29, 2019 (CN) 201910931988.6

(51) Int. Cl. C08G 73/10; C08L 79/08; B29C 39/38; B29C 39/36

(52) U.S. Cl. CPC C08G 73/1067; C08G 73/1003; C08L 79/08; B29K 2279/08; B29C 39/36; C08L 2201/10; B29C 39/38

(57) ABSTRACT

A polyimide precursor solution is disclosed, and a colorless transparent polyimide film manufactured from the polyimide precursor solution. The polyimide precursor solution has diamines, a first dianhydride represented by biphenyl dianhydride, a second dianhydride represented by rigid alicyclic dianhydride, a third dianhydride represented by non-alicyclic dianhydrides and organic solvent. The colorless polyimide films have a modulus of 4.5 GPa or higher, a glass-transition temperature (T_{g}) of 370° C. or higher, and a yellow index of 3.0 or lower. These polyimide films can be used as substrates for thin film transistor (TFT), touch sensor panel (TSP), and cover window applications in flexible display such as organic light-emitting diode (OLED), flexible liquid crystal display (LCD) and other fields.

### CROSS-REFERENCE TO RELATED APPLICATIONS

This application is a non-provisional application that makes a claim of priority to Chinese application 201910931988.6, filed on 29 Sep. 2019.

### TECHNICAL FIELD

The present invention provides a polyimide precursor solution and a colorless transparent polyimide film with high T_{g}, high tensile strength and enhanced modulus.

### BACKGROUND

In recent years, flexible display has attracted much attention in the fields of portable electronics such as smart phone, smart watch, wearable, foldable, and rollable displays for its excellent comprehensive performance. In display technology the substrates are used as a support for functional components such as thin film transistor (TFT), touch sensor panels (TSP), and cover window is used for protection of the viewing screen and the device. They have a critical role in the overall performance and service life of the display device. Traditionally, glass was used as a preferred substrate and cover window in the preparation of display devices such as OLED and LCDs. However, as the displays become lighter, smaller, curved, foldable and rollable, the glass was gradually replaced by other materials particularly transparent plastic substrates. Due to their superior thermomechanical properties, colorless transparent polyimide films are the most preferred material for this application.

At present, colorless transparent polyimide films used for cover window and substrates of display are required to have not only high heat resistance and transmittance, but also must have high modulus for stiffness, and tensile strength for folding endurance.

There are a lot of reports about yellow polyimide films having high modulus, high strength and high heat resistance. These researchers have used rigid aromatic diamines and dianhydrides to synthesize high modulus polyimide films, and some introduced imidazole or oxazole structures in polyimide backbones. But due to the presence of the excessive aromatic nature in the molecular structure, inter- and intra-molecular electronic transitions are easily generated to form charge transfer complexes, so that these films are slightly amber yellow or dark brown colored. In addition, because of the high rigidity of the imidazole or oxazole ring, the films are also less flexible with low folding endurance and difficult to apply for a durable flexible display application.

Generally, reports about transparent polyimide films having high modulus and excellent optical properties are not too many, especially with high tensile strength and high heat resistance at the same time. Also, research for an efficient process to manufacture these colorless polyimide films retaining or further improving mechanical, thermal and optical properties are not common.

United States published application 2016/0237214 A1 reported a method to make transparent polyimide film with improved modulus. With introduction of 10 mol % 5-amino-2-(4-aminophenyl) benzoxazole (6ABO) into the polyimide backbone, the modulus of polyimide film increased from 5.6 to 6.5 Gpa. However, the yellow index (YI) of film also correspondingly increased, particularly by having as low as 5 mol % benzoxazole structure in backbone increased from 2.2 to 3.8. And it also does not mention about thermal properties, making it difficult to assess the heat resistance requirements for flexible devices fabrication.

Chinese patent 108424540A by Tongji University proposed a transparent polyimide film comprising 2,2′-bis(trifluoromethyl)benzidine (TFMB), 1,2,3,4-cyclobutanetetracarboxylic dianhydride (CBDA) and another dianhydride, and these polyimide films have an excellent transmittance. But authors have used only a thermal conversion method to make polyimide film, by heating the polyamic acid precursor at a low temperature heating profile for imidization with a maximum temperature not exceeding 270° C. What's more, the patent has also reported the transmittance of film decreased when temperature exceeded 300° C.

United States published application 2017/0342215 A1 disclosed a method to make transparent polyimide films with high modulus over 4.0 GPa. These reported polyimide films essentially comprised 1,2,3,4-cyclobutanetetracarboxylic dianhydride (CBDA) and 2,2′-dimethyl-4,4′-diaminobiphenyl (m-TD) structure and were imidized by using less than 4 times mol ratio of a base catalyst only to cure the film.

Chinese patent 108431086A disclosed a transparent polyimide film produced by using a mixture of 2,2′-bis(3,4-dicarboxyphenyl) hexafluoropropane dianhydride (6FDA) and CBDA to react with TFMB or a mixture of TFMB/4,4′-diaminodiphenylsulfone (DDS). This polyimide film was also prepared only by thermal conversion method by heating at a maximum temperature not exceeding 300° C., and it has good optical properties with low birefringence. However, the modulus of this film was not reported.

In Chinese patent 105131286B, the authors have disclosed transparent polyimides with high T_{g} and low CTE, which were also manufactured only by the thermal imidization method. These polyimides were produced by reacting p-phenylene diamine (p-PDA) with no more than 20 mol % 1,3-dimethyl-1,2,3,4-cyclobutanetetracarboxylic dianhydride (MCBDA) and at least 80 mol % 3,3′,4,4′-biphenyltetracarboxylic dianhydride (s-BPDA). However, due to the internal charge transfer interaction induced by high stack density of aromatic diamine and dianhydride moieties, these reported films only have a maximum transmittance of less than 84%, and also it is likely to have a higher yellow index.

Chinese patent 109651630A reported a full chemical method to manufacture a transparent polyimide film. This chemical method was conducted with a presence of 1 molar equivalent of catalyst and more than 3 molar equivalents of dehydrant related to polyimide repeat unit. Acetic anhydride was used as dehydrant and methyl pyridine or isoquinoline was used as catalyst. By using a full chemical imidization method, they prepared a transparent colorless polyimide film comprising 12% fluorine atom in backbone, particularly having structure of 4,4′-(4,4′-isopropylidenediphenoxy) bis-(phthalic anhydride) (BPADA)/TFMB, 2,2′-bis[4-(4-aminophenoxy) pheny] hexafluoropropane (HFBAPP)/TFMB. But these monomers containing flexible —O— moieties should produce highly flexible polyimide films with lower heat resistance rather than rigid polyimides.

With the rapid advancement of flexible display technology, there is an urgent need to develop transparent polyimide films with excellent thermal, mechanical and optical properties for substrate applications. There are various reports in the literature about polyimide films having high modulus, high tensile strength, high heat resistance, excellent optical properties and processes to make them. However, none of them meet all the stringent specifications required for the fabrication and use in flexible display applications. The polyimide film with a high modulus can improve service life of flexible display. Especially, it helps to fabricate flexible components requiring high temperature processing where high heat resistance (350° C. or higher) and dimensional stability for the film at elevated temperatures are required. Thus, it is important to develop a polyimide film with excellent thermomechanical properties and heat resistance.

### SUMMARY

The present invention is intended to provide a polyimide precursor solution which is made from diamines and dianhydrides in organic solvent, wherein the dianhydrides comprise a first dianhydride represented by biphenyl dianhydride, a second dianhydride represented by rigid alicyclic dianhydride and a third dianhydride represented by non-alicyclic dianhydride.

Wherein, relative to all dianhydrides which can be considered as 100 mol %, the first dianhydride containing biphenyl structure is in an amount of 10 to 80 mol %;

the second dianhydride represented by rigid alicyclic dianhydride is in an amount of 10 to 80 mol %;

the third dianhydride represented by non-alicyclic dianhydride is in an amount of 10 to 80 mol %;

Wherein the diamine comprises one or more selected from 1,4-diamino-2,3,5,6-tetrafluorobenzene, 2-(trifluoromethyl)benzene-1,4-diamine, 4,4′-diaminooctafluorobiphenyl and 2,2′-bis(trifluoromethyl)benzidine.

Wherein the first dianhydride comprises biphenyl dianhydride which can be represented by Structural Formula (I):

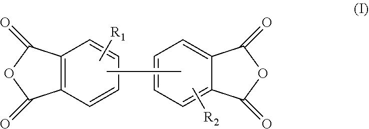

In this case, R₁ and R₂ are each independently selected from a hydrogen (—H), a halogen atom such as —F, —Cl, —Br, —I, a nitro group (—NO₂), a C₁₋₄ halogenoalkoxyl group, a C₁₋₁₀ alkyl group, a C₁₋₁₀ halogenoalkyl group, a C₆₋₂₀ aryl group and a C₁₋₁₀ alkyl group;

the second dianhydride comprises a rigid alicyclic dianhydride which can be represented by Structural Formula (II):

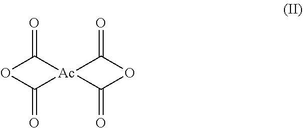

wherein the Ac is selected from any of the following groups:

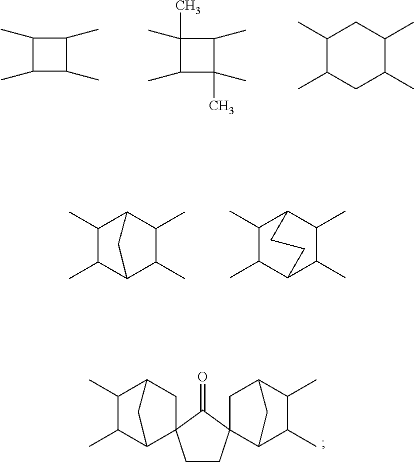

and

the third dianhydride represented by non-alicyclic dianhydride comprises one or more selected from 4,4′-(hexafluoroisopropylidene)diphthalic anhydride, 9,9-bis(phthalic anhydride) fluorene, 1,4,5,8-naphthalenetetracarboxylic dianhydride, 4,4′-(4,4′-isopropylidenediphenoxy)diphthalic anhydride, 4,4′-oxydiphthalic anhydride, 3,3′,4,4′-benzophenonetetracarboxylic dianhydride, pyromellitic dianhydride and 3,3′,4,4′-diphenylsulfonetetracarboxylic dianhydride.

The polyimide precursor solution of the present invention is preferably manufactured in an organic solvent. The organic solvent used in polymerizing the diamine and dianhydride may comprise one or more aprotic solvents selected from cyclic esters such as γ-valerolactone, γ-butyrolactone and α-methyl-γ-butyrolactone; amide solvents such as N-methyl-2-pyrrolidone (NMP), dimethylformamide (DMF), dimethylacetamide (DMAc) and dimethyl sulfoxide (DMSO); phenol solvents such as p-cresol, m-cresol; and other solvents such as sulfolane, acetophenone, etc. The solvent used in the present invention is not limited to the above mentioned.

According to one embodiment, the organic solvent in the present invention can comprise one or more selected from N-methyl-2-pyrrolidone (NMP), dimethylacetamide (DMAc), dimethyl sulfoxide (DMSO), dimethylformamide (DMF), m-cresol, ethyl acetate, acetone and γ-butyrolactone.

According to one embodiment of the present invention, the diamine and the dianhydride are polymerized in DMAc solvent at a molar ratio of 1:0.95 to 1:1.2, preferably 1:0.98 to 1:1.05, and at a reaction temperature of −20 to 60° C. for a reaction time of 4 to 48 hr. in a nitrogen or argon atmosphere, thus preparing polyimide precursor solution.

The solid content based on a polyimide precursor solution is 10 mass % to 35 mass %, preferably 15 mass % to 30 mass %, relative to the total amount of the polyimide precursor and solvent.

The other object of the present invention is to provide a polyimide film, which is prepared from the polyimide precursor solution above. Wherein the polyimide film according to the embodiment of the present invention may have a yellow index of 3.0 or less, a haze of 1.0% or less and an average light transmittance of 89% or more at 550 nm, a high glass-transition temperature (T_{g}) of 370° C. or more. Particularly, the polyimide film according to the embodiment of the present invention may have a modulus of 4.5 Gpa or more, a tensile strength of 110 MPa or more.

In addition, the other object of the present invention is to provide a method for manufacturing a polyimide film. The method comprises the steps of:

obtaining a polyimide film by imidizing the polyimide precursor solution described above with the method of thermal imidization, chemical imidization or other combinatorial methods.

In this method, “thermal imidization” means that the polyimide precursor solution was spread and cast on a glass plate, then finished with imidization in a high temperature oven.

The “chemical imidization” method means that the polyimide precursor solution was mixed with catalyst and dehydrant, then spread and cast on a glass plate, then completed with imidization in a high temperature oven.

A catalyst used in chemical imidization may comprise one or more selected from pyridine, picolines, quinolines, isoquinoline compounds, quinolones, imidazoles, benzimidazole compounds, etc. And a dehydrant used in chemical imidization may comprise one or more selected from acetic anhydride, propionic anhydride, butyric anhydride, benzoic anhydride, etc.

Typically, the polyimide precursor solution or the mixture thereof (with catalyst & dehydrant) which was spread and cast on a glass plate was dried in the temperature range of 50° C. to 180° C. for 8 to 60 min in an oven or on a heating panel to remove most of the solvent, then heated at a temperature range of 250° C. to 500° C. for 10 to 120 min in an oven to complete the imidization, or peeled off the film from the glass support after removing most of the solvent, then fixing on stainless steel frame and heating up to finish the imidization, thus preparing a polyimide film.

Generally, the polyimide film would easily deteriorate to become yellow in the high temperature imidization process. In order to prevent the oxidative deterioration, the heat treatment is usually carried out under an inert gas such as nitrogen or argon, preferably in a nitrogen atmosphere.

In addition, thickness of the polyimide film according to the present invention is not particularly limited, and is preferably 5 to 250 μm, and more preferably 10 to 125 μm.

Especially, in the present invention, the method of full chemical imidization was used to achieve these excellent optical, mechanical properties and thermal properties required for the display applications. The colorless polyimide films disclosed in the present invention which possesses excellent mechanical properties and heat resistance at the same time, having a modulus of 4.5 GPa or higher, a glass-transition temperature (T_{g}) of 370° C. or higher, and a yellow index of 3.0 or lower. These polyimide films can be used as substrates for thin film transistor (TFT), touch sensor panel (TSP), and cover window applications in flexible display such as organic light-emitting diode (OLED), flexible liquid crystal display (LCD) and other fields.

### BEST MODE

Hereinafter, the present invention will be described more fully with reference to the following embodiments. Furthermore, the embodiments are not limited to the aspects described in the present description.

The chemical reagents used in the embodiment are all commercial products.

The methods involved in the embodiments for measuring the properties are as described as below:

### (1) Light Transmittance, b*, Yellow Index and Haze

The Light Transmittance, b value, yellow index and Haze of polyimide films were measured using a spectrophotometer (X-rite Ci7800), all the values were averaged.

### (2) Glass-Transition Temperature (T_{g})

The glass-transition temperature of polyimide films were measured with method of Dynamic Mechanical Analyzer (DMA850) under the conditions of load of 0.05N, a heating rate of 3° C./min and a nitrogen atmosphere at 200° C. to 500° C., and then an inflection point of a curve with the max value was recorded as a glass-transition temperature.

### (3) The Thermal Expansion Coefficient (CTE)

The thermal expansion coefficient of polyimide films were measured two times in the range of 50˜250° C. with the method of Thermomechanical Analyzer (TMA 7100C) under the conditions of a load of 20 mN, a heating rate of 10° C./min with the first test, and a heating rate of 5° C./min with the second test.

### (4) Mechanical Properties (Elongation, Tensile Stress, Young's Modulus)

The mechanical properties including tensile stress, elongation and Young's modulus of polyimide films were measured using an electronic universal testing machine (CMT2103) at a rate of 100 mm/min.

### EXAMPLE 1

The nitrogen was passed through a 500 mL three-neck round bottom flask reactor which was equipped with a stirrer, a nitrogen inlet and a thermometer, 226.158 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 11.7688 g (0.04 mol) of 4,4′-(hexafluoroisopropylidene)diphthalic anhydride (6FDA), 2.9422 g (0.01 mol) of 3,3′,4,4′-biphenyltetracarboxylic dianhydride (s-BPDA) and 9.8055 g (0.05 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film can be obtained by imidizing the polyimide precursor solution with the method of thermal imidization and chemical imidization.

Thermal imidization was described in detail as the following steps: the polyimide precursor solution above was cast and spread on a glass support, then heated in an oven with the temperature of 100° C. for 12 min to remove most of the solvent, and then heated at a temperature of 300° C. again to finish the imidization or peeled off from the glass support and fixed on stainless steel frame, then placed the stainless steel frame with the film above into a nitrogen oven and heated from 150° C. to 300° C. at a rate of 5° C./min, and kept at 300° C. for 15 min, then slowly cooled and separated from the frame, thus obtaining the polyimide film.

Chemical imidization was described in detail as the following steps: 6.29 g of pyridine and 8.12 g of acetic anhydride were added to 100 g of polyimide precursor solution with stirring for 2-12 hr. Then the mixture was cast and spread on a glass substrate and dried in an oven at a temperature of 100° C. for 12 min to remove most of the solvent, and then heated at a temperature of 300° C. again to finish the imidization, or peeled off from the glass support and fixed on a stainless steel frame, then placed the stainless steel frame with the film above into a nitrogen oven and heated from 150° C. to 300° C. at a rate of 5° C./min and kept at 300° C. for 15 min, then slowly cooled and separated from the frame, thus obtaining the polyimide film.

### EXAMPLE 2

The nitrogen was passed through a 500 mL three-neck round bottom flask reactor which was equipped with a stirrer, a nitrogen inlet and a thermometer, 240.236 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 13.3272 g (0.03 mol) of 4,4′-(hexafluoroisopropylidene)diphthalic anhydride (6FDA), 2.9422 g (0.01 mol) of 3,3′,4,4′-biphenyltetracarboxylic dianhydride (s-BPDA) and 11.767 g (0.06 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 6.55 g of pyridine and 8.46 g of acetic anhydride to the 100 g of polyimide precursor solution.

### EXAMPLE 3

The nitrogen was passed through a 500 mL three-neck round bottom flask reactor which was equipped with a stirrer, a nitrogen inlet and a thermometer, 230.31 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 8.8848 g (0.02 mol) of 4,4′-(hexafluoroisopropylidene)diphthalic anhydride (6FDA), 2.9422 g (0.01 mol) of 3,3′,4,4′-biphenyltetracarboxylic dianhydride (s-BPDA) and 13.73 g (0.07 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 6.84 g of pyridine and 8.83 g of acetic anhydride to the 100 g of polyimide precursor solution.

### EXAMPLE 4

The nitrogen was passed through a 500 mL three-neck round bottom flask reactor which was equipped with a stirrer, a nitrogen inlet and a thermometer, 273.42 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 27.5058 g (0.06 mol) of 9,9′-bis(phthalic anhydride) fluorene (BPAF), 2.9422 g (0.01 mol) of 3,3′,4,4′-biphenyltetracarboxylic dianhydride (s-BPDA) and 5.8833 g (0.03 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 5.76 g of pyridine and 7.43 g of acetic anhydride to the 100 g of polyimide precursor solution.

### EXAMPLE 5

The nitrogen was passed through a 500 mL three-neck round bottom flask reactor which was equipped with a stirrer, a nitrogen inlet and a thermometer, 252.43 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 18.3372 g (0.04 mol) of 9,9′-bis(phthalic anhydride) fluorene (BPAF), 2.9422 g (0.01 mol) of 3,3′,4,4′-biphenyltetracarboxylic dianhydride (s-BPDA) and 9.8055 g (0.05 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 6.24 g of pyridine and 8.05 g of acetic anhydride to the 100 g of polyimide precursor solution.

### EXAMPLE 6

The nitrogen was passed through a 500 mL three-neck round bottom flask reactor which was equipped with a stirrer, a nitrogen inlet and a thermometer, 231.446 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 9.1686 g (0.02 mol) of 9,9′-bis(phthalic anhydride) fluorene (BPAF), 2.9422 g (0.01 mol) of 3,3′,4,4′-biphenyltetracarboxylic dianhydride (s-BPDA) and 13.73 g (0.07 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 6.8 g of pyridine and 8.78 g of acetic anhydride to the 100 g of polyimide precursor solution.

### EXAMPLE 7

The nitrogen was passed through a 500 mL three-neck round bottom flask reactor which was equipped with a stirrer, a nitrogen inlet and a thermometer, 252.388 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 11.46 g (0.025 mol) of 9,9′-bis(phthalic anhydride) fluorene (BPAF), 14.711 g (0.05 mol) of 3,3′,4,4′-biphenyltetracarboxylic dianhydride (s-BPDA) and 4.903 g (0.025 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 6.49 g of pyridine and 8.38 g of acetic anhydride to the 100 g of polyimide precursor solution.

### EXAMPLE 8

The nitrogen was passed through a 500 mL three-neck round bottom flask reactor which was equipped with a stirrer, a nitrogen inlet and a thermometer, 242.596 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 11.46 g (0.025 mol) of 9,9′-bis(phthalic anhydride) fluorene (BPAF), 7.356 g (0.025 mol) of 3,3′,4,4′-biphenyltetracarboxylic dianhydride (s-BPDA) and 9.81 g (0.05 mol) of 1,2,3,4-cyclobutanetetracarboxylic dianhydride (CBDA) were added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 6.24 g of pyridine and 8.05 g of acetic anhydride to the 100 g of polyimide precursor solution.

### COMPARATIVE EXAMPLE 1

The nitrogen was passed through a 500 mL three-neck round bottom flask reactor which was equipped with a stirrer, a nitrogen inlet and a thermometer, 305.788 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 44.424 g (0.1 mol) of 4,4′-(hexafluoroisopropylidene)diphthalic anhydride (6FDA) was added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 5.14 g of pyridine and 6.64 g of acetic anhydride to the 100 g of polyimide precursor solution.

### COMPARATIVE EXAMPLE 2

The nitrogen was passed through a 500 mL three-neck round bottom flask reactor which was equipped with a stirrer, a nitrogen inlet and a thermometer, 311.264 g of N,N-dimethylacetamide (DMAc) was placed in the reactor as a solvent. Then 32.023 g (0.1 mol) of 2,2′-bis(trifluoromethyl)benzidine (TFMB) was dissolved therein. Thereafter, 45.843 g (0.1 mol) of 9,9′-bis(phthalic anhydride) fluorene (BPAF) was added thereto. The resulting solution was kept at room temperature and reacted for 8-48 hr., thus obtaining a polyimide precursor solution with the solid content of 20 wt. %.

The polyimide film was formed in the same way as in example 1 with the method of thermal imidization and chemical imidization. Wherein, the chemical imidization was carried out by adding 5.05 g of pyridine and 6.52 g of acetic anhydride to the 100 g of polyimide precursor solution.

The following properties of the polyimide films manufactured in examples and comparative examples above were measured: (1) Light Transmittance, b*, yellow index and Haze; (2) Glass-Transition Temperature (Tg); (3) The Thermal Expansion Coefficient (CTE); (4) Mechanical Properties (elongation, tensile stress, Young's modulus); (5) 5% weight loss temperature. Data from the above experiments are presented below in Tables 1 through 3. In Tables 1 and 2, the symbol “/” means that the film produced was very brittle and unable to be measured.

Properties of the films from thermal imidization and chemical imidization methods are shown in Tables 1 to 3, respectively. According to these results, the polyimide films of Examples 1 to 8 have high transparency, a yellow index of 3 or less, a Young's modulus of 4.5 GPa or more, and a tensile strength of 110 MPa or higher. In addition, the polyimide films according to the present invention also have glass-transition temperatures (T_{g}) of 370° C. or higher. Besides, the Examples 1 to 8 in Tables 1 to 3 show that the Young's modulus of polyimide films can be increased by introducing biphenylene and rigid alicyclic structure contents, and when these structural contents increased, polyimide films modulus were also increased. Therefore, by comparing Comparative Example 1 with Examples 1 through 3, and Comparative Example 2 with Examples 4 through 8, when biphenylene and rigid alicyclic structures were introduced, the Young's modulus have been significantly increased.

Further, and as demonstrated in Tables 1 to 3 described above, the Examples and comparative Examples show that the polyimide films made with the method of thermal imidization method are colored and more brittle with poor mechanical and thermal properties, compared to the films made with the chemical imidization method. The polyimide films of the present invention made by the chemical imidization method show better properties.

In conclusion, the polyimide films according to the present invention can improve Young's modulus by the introduction of biphenylene and rigid alicyclic structures into the backbone of the polymer, that also possess high heat resistance and transparency at the same time. In addition, in the present invention the transparent polyimide films with better properties can only be manufactured by the method of chemical imidization, and thus achieved these excellent optical, mechanical properties and thermal properties required for the display applications.

TABLE 1
Thermal imidization method

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 |
| diamine | TFMB | 100 | 100 | 100 | 100 | 100 | 100 | 100 | 100 | 100 | 100 |
| dianhydride | 6FDA | 40 | 30 | 20 | | | | | | 100 | |
| | s-BPDA | 10 | 10 | 10 | 10 | 10 | 10 | 25 | 50 | | |
| | BPAF | | | | 60 | 40 | 20 | 25 | 25 | | 100 |
| | CBDA | 50 | 60 | 70 | 30 | 50 | 70 | 50 | 25 | | |
| film thickness (μm) | | 22 | 23.5 | 22.5 | / | / | / | / | / | 20 | / |
| Transmittance | 400-700 nm | 89.4 | 89.3 | 89.2 | / | / | / | / | 88.9 | / | / |
| (%) | 550 nm | 90.5 | 90.4 | 90.3 | / | / | / | / | 90.26 | / | / |

| | | | | | | | | | | |
|---|---|---|---|---|---|---|---|---|---|---|
| b* | 1.6 | 1.6 | 1.7 | / | / | / | / | / | 1.7 | / |
| YI | 2.7 | 2.8 | 3.0 | / | / | / | / | / | 2.3 | / |
| Elongation (%) | / | / | / | / | / | / | / | / | 9.03 | / |
| Tensile strength (Mpa) | / | / | / | / | / | / | / | / | 123.0 | / |
| Young's modular (Gpa) | 4.5 | / | / | / | / | / | / | / | 3.6 | / |
| Haze (%) | 0.1 | 0.1 | 0.0 | / | / | / | / | / | 0.3 | / |
| T_{g} (° C.) | / | / | / | / | / | / | / | / | 337 | / |
| CTE 1^{st} scan | 34.45 | 31.4 | 27.5 | / | / | / | / | / | 39 | / |
| (ppm/° C.; 50-250 C.) | | | | | | | | | | |
| CTE 2^{nd} scan | 63.4 | 53.4 | 51.1 | / | / | / | / | / | 65.94 | / |
| (ppm/° C.; 50-250 C.) | | | | | | | | | | |
| 5% weight loss temperature/° C. | 459.7 | 470.7 | 480.3 | / | / | / | / | / | 477.2 | / |

TABLE 2
Chemical imidization method (polymer cured on stainless steel frame)

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 |
| Diamine | TFMB | 100 | 100 | 100 | 100 | 100 | 100 | 100 | 100 | 100 | 100 |
| dianhydride | 6FDA | 40 | 30 | 20 | | | | | | 100 | |
| | s-BPDA | 10 | 10 | 10 | 10 | 10 | 10 | 25 | 50 | | |
| | BPAF | | | | 60 | 40 | 20 | 25 | 25 | | 100 |
| | CBDA | 50 | 60 | 70 | 30 | 50 | 70 | 50 | 25 | | |
| film thickness (μm) | | 20 | 21 | 31.5 | 27.5 | 27.0 | 21.5 | 22 | 23 | 25.0 | 29.0 |
| Transmittance | 400-700 nm | 89.8 | 89.2 | 88.7 | 88.5 | 88.3 | 88.4 | 88.2 | 88.0 | 90.7 | 88.5 |
| (%) | 550 nm | 90.4 | 89.9 | 89.6 | 89.4 | 89.1 | 89.3 | 89.1 | 89.0 | 90.9 | 89.0 |

| | | | | | | | | | | |
|---|---|---|---|---|---|---|---|---|---|---|
| b* | 0.8 | 1.0 | 1.3 | 0.9 | 1.0 | 1.2 | 1.4 | 1.3 | 0.4 | 0.8 |
| YI | 1.4 | 1.8 | 2.2 | 1.7 | 1.8 | 2.1 | 2.5 | 2.4 | 1.4 | 1.5 |
| Elongation (%) | 11.9 | 12.5 | 16.2 | 4.3 | 5.3 | 11.2 | 10.8 | 11.1 | 6.9 | 3.5 |
| Tensile strength (Mpa) | 153.6 | 173.5 | 193.4 | 114.6 | 131.1 | 223.7 | 157.5 | 158.1 | 132.9 | 107.9 |
| Young's modulus (Gpa) | 4.9 | 5.7 | 6.3 | 4.6 | 4.9 | 6.8 | 5.8 | 5.7 | 3.3 | 3.8 |
| Haze (%) | 0.3 | 0.3 | 0.5 | 0.4 | 0.4 | 0.6 | 0.2 | 0.3 | 0.4 | 0.8 |
| T_{g} (° C.) | 376.5 | 373.7 | 373.9 | 385.3 | 389.3 | 387.6 | 377.8 | 375.5 | 340.7 | 414.3 |
| CTE 1^{st} scan | 15.9 | 9.5 | 10.8 | 19.9 | 12.4 | 2.0 | 5.2 | 3.9 | 30 | 39.7 |
| (ppm/° C.; 50-250 C.) | | | | | | | | | | |
| CTE 2^{nd} scan | 38.6 | 27.3 | 22.2 | 40.6 | 33.5 | 17.9 | 21.0 | 19.6 | 62.3 | 54.5 |
| (ppm/° C.; 50-250 C.) | | | | | | | | | | |
| 5% weight loss temperature/° C. | 484.5 | 490.8 | 500.5 | 479.2 | 525.2 | 541.7 | 544.2 | 545.7 | 479.8 | 573.9 |

TABLE 3
Chemical imidization method (polymer cured on glass plate)

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 |
| diamine | TFMB | 100 | 100 | 100 | 100 | 100 | 100 | 100 | 100 | 100 | 100 |
| dianhydride | 6FDA | 40 | 30 | 20 | | | | | | 100 | |
| | s-BPDA | 10 | 10 | 10 | 10 | 10 | 10 | 25 | 50 | | |
| | BPAF | | | | 60 | 40 | 20 | 25 | 25 | | 100 |
| | CBDA | 50 | 60 | 70 | 30 | 50 | 70 | 50 | 25 | | |
| film thickness (μm) | | 10 | 10 | 10 | 10 | 10 | 10 | 10 | 10 | 10 | 10 |
| Transmittance | 400-700 nm | 89.7 | 89.5 | 89.5 | 88.7 | 89.0 | 89.0 | 88.9 | 89.0 | 90.9 | 88.5 |
| (%) | 550 nm | 90.2 | 90.0 | 89.9 | 89.1 | 89.4 | 89.3 | 89.4 | 89.4 | 91.2 | 88.8 |

| | | | | | | | | | | |
|---|---|---|---|---|---|---|---|---|---|---|
| b* | 0.7 | 0.7 | 0.8 | 0.7 | 0.7 | 0.9 | 1.1 | 1.1 | 0.3 | 0.7 |
| YI | 1.2 | 1.3 | 1.4 | 1.3 | 1.3 | 1.7 | 1.8 | 1.8 | 1.2 | 1.3 |
| Elongation (%) | 3.5 | 5.8 | 5.5 | 4.7 | 4.8 | 5.7 | 5.1 | 5.8 | 3.5 | 4.1 |
| Tensile strength (Mpa) | 114.1 | 173.8 | 176.9 | 142.7 | 150.6 | 206.7 | 160.4 | 161.2 | 129.3 | 108.1 |
| Young's modulus (Gpa) | 5.0 | 6.3 | 6.7 | 4.9 | 5.5 | 6.9 | 5.9 | 5.8 | 3.5 | 4.0 |
| Haze (%) | 0.0 | 0.1 | 0.1 | 0.0 | 0.0 | 0.1 | 0.0 | 0.1 | 0.0 | 0.0 |
| T_{g} (° C.) | 375.3 | 376.1 | 372.4 | 388.7 | 387.4 | 389.0 | 388.1 | 387.9 | 341.5 | 415.7 |
| CTE 1^{st} scan | 8.3 | 7.1 | 7.1 | 13.9 | 4.5 | 1.7 | 3.9 | 2.1 | 27.2 | 36.1 |
| (ppm/° C.; 50-250 C.) | | | | | | | | | | |
| CTE 2^{nd} scan | 36.8 | 24.2 | 19.2 | 39.3 | 30.7 | 15.3 | 19.1 | 17.2 | 59.7 | 51.7 |
| (ppm/° C.; 50-250 C.) | | | | | | | | | | |
| 5% weight loss temperature/° C. | 483.1 | 491.2 | 499.7 | 480.3 | 527.4 | 540.3 | 546.1 | 547.2 | 480.1 | 574.1 |

What is claimed is:

1. A polyimide precursor solution manufactured by reacting, in an organic solvent:
one or more diamines;
a first dianhydride represented by biphenyl dianhydride;
a second dianhydride represented by rigid alicyclic dianhydride, and
a third dianhydride represented by non-alicyclic dianhydride;
wherein relative to all dianhydrides which can be considered as 100 mol %, the first dianhydride containing biphenyl structure is in an amount of 10 to 80 mol %;
the second dianhydride represented by rigid alicyclic dianhydride is in an amount of 10 to 80 mol %; and
the third dianhydride represented by non-alicyclic dianhydride is in an amount of 10 to 80 mol %.

2. The polyimide precursor solution of claim 1, wherein:
the one or more diamines are selected from the group consisting of: 1,3-diamino-2,4,5,6-tetrafluorobenzene, 2-(trifluoromethyl) benzene-1,4-diamine, 4,4′-diaminooctafluorobiphenyl, 2,2′-bis(trifluoromethyl) benzidine and combinations thereof.

3. The polyimide precursor solution of claim 1, wherein:
the first dianhydride comprises biphenyl dianhydrides which can be represented by Structural Formula (I): 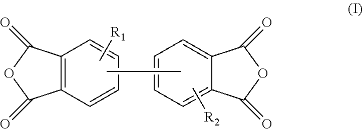
such that R₁ and R₂ are each independently selected from a hydrogen (—H), a halogen atom such as —F, —Cl, —Br, —I, a nitro group (—NO₂), a C₁₋₄ halogenoalkoxyl group, a C₁₋₁₀ alkyl group, a C₁₋₁₀ halogenoalkyl group, a C₆₋₂₀ aryl group and a C₁₋₁₀ alkyl group;
the second dianhydride comprises rigid alicyclic dianhydrides represented by Structural Formula (II): 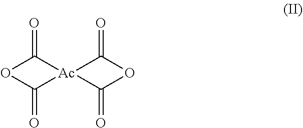
wherein the Ac is selected from any of the following groups: 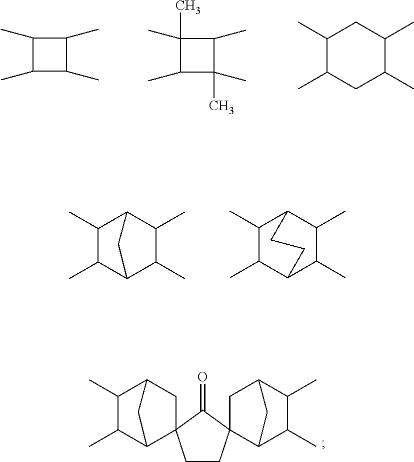
and
the third dianhydride comprises one or more selected from the group consisting of: 1,4,5,8-naphthalenetetracarboxylic dianhydride, 4,4′-(hexafluoroisopropylidene)diphthalic anhydride, 9,9-bis(phthalic anhydride) fluorene, 4,4′-(4,4′-isopropylidenediphenoxy)diphthalic anhydride, 4,4′-oxydiphthalic anhydride, 3,3′,4,4′-benzophenonetetracarboxylic dianhydride, pyromellitic dianhydride and 3,3′,4,4′-diphenylsulfonetetracarboxylic dianhydride.

4. The polyimide precursor solution of claim 1, wherein the organic solvent is selected from the group consisting of: N-methyl-2-pyrrolidone (NMP), dimethylacetamide (DMAc), dimethyl sulfoxide (DMSO), dimethylformamide (DMF), m-cresol, ethyl acetate, acetone, γ-butyrolactone and combinations thereof.

5. A colorless and transparent polyimide film manufactured from the polyimide precursor solution of claim 1.

6. The polyimide film of claim 5, having at least the following features:
a yellow index of 3.0 or less;
a Young's modulus of 4.5 GPa or higher, with a tensile strength exceeding 110 MPa;
a glass-transition temperature (T_{g}) of at least 370° C.; and
a transmittance of at least 89% at 550 nm, with a haze not exceeding 1.0%.

7. A method for manufacturing the transparent polyimide film of claim 5, comprising a thermal imidization process, a chemical imidization process or some other imidization processes.

8. The method of claim 7, wherein the chemical imidization process comprises the steps of:
mixing the polyimide precursor solution of claim 1 with a catalyst and a dehydrant and stirring for 1 to 12 hours to obtain a mixture;
casting the mixture on a glass plate or other substrate, and drying to remove the solvent, obtaining a semi-dried film; and
producing the transparent polyimide film from the semi-dried film.

9. The method of claim 8, wherein the step of drying to remove the solvent is achieved at a temperature of 50 to 180° C. for 8 to 60 minutes.

10. The method of claim 8, wherein the step of obtaining the transparent polyimide film is achieved by directly heating the film again at a high temperature.

11. The method of claim 8, wherein the step of obtaining the transparent polyimide film is achieved by peeling the film off of the glass substrate, fixing the film on a stainless-steel frame, and heating the peeled film at the highest temperature range of 250 to 500° C. for a time of 10 to 120 minutes.

12. The method of claim 8, wherein:
the catalyst is selected from the group consisting of: pyridine, isoquinoline compounds, quinolone compounds, imidazole compounds, benzimidazole compounds, and combinations thereof; and
the dehydrant is selected from the group consisting of: acetic anhydride, propionic anhydride, butyric anhydride, benzoic anhydride, and combinations thereof.

13. A flexible display and cover window, comprising:
a substrate of the colorless and transparent polyimide film of claim 5.
